(19) United States
(12) Patent Application Publication
(10) Pub. No.: US 2026/0054173 A1
(43) Pub. Date: Feb. 26, 2026

(54) SEASON INFORMATION PRESENTATION METHOD AND APPARATUS, DEVICE, AND STORAGE MEDIUM

(71) Applicant: Tencent Technology (Shenzhen) Company Limited, Shenzhen (CN)

(72) Inventor: Liang ZHANG, Shenzhen (CN)

(21) Appl. No.: 19/374,202

(22) Filed: Oct. 30, 2025

Related U.S. Application Data
(63) Continuation of application No. PCT/CN2024/137716, filed on Dec. 9, 2024.

(30) Foreign Application Priority Data
Jan. 18, 2024 (CN) 202410077289.0

(51) Int. Cl. A63F 13/533; A63F 13/55; A63F 13/70

(52) U.S. Cl. CPC A63F 13/533; A63F 13/55; A63F 13/70

(57) ABSTRACT

Provided are a season information display method performed by a computer device. The method includes: displaying a season stage presentation interface of an application program; in response to a first user instruction, displaying stage prompt information on the season stage presentation interface, the stage prompt information indicating that the application program is currently in a first season stage of the at least two season stages; in response to a second user instruction, replacing the stage prompt information with value prompt information of the first season stage on the season stage presentation interface, the value prompt information prompting a value range configured for an interactive object in the application program in the first season stage; and changing the value range in response to the application program switching from the first season stage to a second season stage of the at least two season stages.

### CROSS-REFERENCE TO RELATED APPLICATIONS

This application is a continuation application of PCT Patent Application No. PCT/CN2024/137716, entitled “SEASON INFORMATION PRESENTATION METHOD AND APPARATUS, DEVICE, AND STORAGE MEDIUM” filed on Dec. 9, 2024, which claims priority to Chinese Patent Application No. 202410077289.0, entitled “SEASON INFORMATION PRESENTATION METHOD AND APPARATUS, DEVICE, AND STORAGE MEDIUM” filed on Jan. 18, 2024, both of which are incorporated herein by reference in their entirety.

### FIELD OF THE TECHNOLOGY

This application relates to the field of computer technologies, and in particular, to a season information presentation method and apparatus, a device, and a storage medium.

### BACKGROUND OF THE DISCLOSURE

The season mechanism, as a common mechanism, provides continuous vividness for an application program.

In the related art, season design of a related application program includes accumulating, in a season, virtual props obtained by a user, and settling and resetting the virtual props after the season ends. Specifically, the user may obtain a virtual prop with a relatively high attribute value in any season progress of the season.

Based on such a design, if a user enters a season in an early stage of the season, it is fair that a plurality of users are on a same starter line. However, if a user enters the season in a middle stage of the season, a strength difference between the user and another user caused by accumulation based on a time length is difficult for the user to make up for. It is difficult for a user having a relatively large strength difference to participate in the same scene. Consequently, a server experiences a relatively high matching load in the middle and late stages of the season.

### SUMMARY

This application provides a season information presentation method and apparatus, a device, and a storage medium. The technical solutions provided in embodiments of this application are as follows:

According to an aspect of the embodiments of this application, a season information presentation method is provided. The method is performed by a terminal device, and the method includes:
displaying a season stage presentation interface of an application program, a season of the application program including at least two season stages;
in response to a first user instruction, displaying stage prompt information on the season stage presentation interface, the stage prompt information indicating that the application program is currently in a first season stage of the at least two season stages;
in response to a second user instruction, replacing the stage prompt information with value prompt information of the first season stage on the season stage presentation interface, the value prompt information prompting a value range configured for an interactive object in the application program in the first season stage; and
changing the value range in response to the application program switching from the first season stage to a second season stage of the at least two season stages.

According to an aspect of the embodiments of this application, a computer device is provided. The computer device includes a processor and a memory, the memory has a computer program stored therein, and the computer program, when loaded and executed by the processor, causes the computer device to implement the foregoing season information presentation method.

According to an aspect of the embodiments of this application, a non-transitory computer-readable storage medium is provided. The storage medium has a computer program stored therein, and the computer program, when loaded and executed by a processor of a computer device, causes the computer device to implement the foregoing season information presentation method.

A scene screen of a match is displayed in response to a matching operation for the match. An attribute value of a user virtual object participating in the match falls within a value range of the user virtual object, the user virtual object carries at least one virtual prop into the match, and an attribute value of the virtual prop falls within a value range of the virtual prop. In some embodiments, a number of virtual props allowed to be carried by the user virtual object is preset. In this way, although the strength of the user virtual object can be enhanced by the virtual prop, the overall strength of the user virtual object is limited by the value range of the user virtual object and the value range of the virtual prop. Within a particular value range, a strength difference between user virtual objects in the same match is not excessively large.

In the match, a virtual prop in the match is obtained in response to a picking operation for the virtual prop in the match. An attribute value of the virtual prop in the match falls within a value range of the virtual prop. In some embodiments, the virtual prop in the match may be dropped after a monster virtual object in the match is defeated, or may be rewarded after a match goal is achieved, or may be obtained by interacting with an interactive object in the match. An attribute value of a virtual prop obtained by a user in the match also falls within the value range of the virtual prop. In this way, after the user obtains the virtual prop, the strength of a user virtual object of the user can still be limited within a particular value range.

A complete season is divided into a plurality of different season stages, and attribute values of interactive objects in the season stages are differently set, whereby the problem of an excessively large strength difference between different users in the same season caused by different duration is alleviated, the strength of different users in the same season is aligned, and a strength difference between different users is reduced. This allows each user to be free from strength constraints in the season and experience as much scene content as possible, and enhances the play rate of scene content. For a backend server supporting an application program, this mechanism reduces a strength difference between users and increases a number of candidate users that can be matched in the same time period. Therefore, the server can quickly perform user matching, and computational load on the server during logic matching is reduced.

### BRIEF DESCRIPTION OF THE DRAWINGS

FIG. 1 is a schematic diagram of a solution implementation environment according to an exemplary embodiment of this application.

FIG. 2 is a schematic diagram of a process of dividing a session into a plurality of different season stages according to an exemplary embodiment of this application.

FIG. 3 is a flowchart of a season information presentation method according to an exemplary embodiment of this application.

FIG. 4 is a schematic diagram of a display style of value prompt information according to an exemplary embodiment of this application.

FIG. 5 is a schematic diagram of an effect of a first display area according to an exemplary embodiment of this application.

FIG. 6 is a flowchart of a season information presentation method according to another exemplary embodiment of this application.

FIG. 7 is a diagram of an effect of a season stage presentation interface according to an exemplary embodiment of this application.

FIG. 8 is a diagram of an effect of displaying an operation prompt animation in an object presentation frame according to an exemplary embodiment of this application.

FIG. 9 is a diagram of an effect of interaction effect comparison in an object presentation frame according to an exemplary embodiment of this application.

FIG. 10 is a diagram of a display frame of a season stage presentation interface according to an exemplary embodiment of this application.

FIG. 11 is a flowchart of a season information presentation method according to another exemplary embodiment of this application.

FIG. 12 is a schematic diagram of a game screen according to an exemplary embodiment of this application.

FIG. 13 is a schematic diagram of an attribute value determination process according to an exemplary embodiment of this application.

FIG. 14 is a block diagram of a season information presentation apparatus according to an exemplary embodiment of this application.

FIG. 15 is a structural block diagram of a terminal device according to an exemplary embodiment of this application.

### DESCRIPTION OF EMBODIMENTS

To make the objectives, technical solutions, and advantages of this application clearer, the following further describes implementations of this application in detail with reference to the accompanying drawings.

FIG. 1 is a schematic diagram of a solution implementation environment according to an exemplary embodiment of this application. The solution implementation environment may be implemented as a computer system such as an application program system. The solution implementation environment may include: a terminal device 10 and a server 20.

The terminal device 10 may be an electronic device such as a mobile phone, a tablet computer, a personal computer (PC), a game console, a multimedia playback device, a wearable device, an intelligent voice interaction device, an intelligence appliance, an on-board terminal, a virtual reality device, or an augmented reality device.

In an example, the terminal device 10 runs an application program, and the application program can provide a season division function. Exemplarily, the application program may be a live streaming application program where a streamer performs different tasks during a season to advance in rank. Exemplarily, the application program may be a game application program. The game application program includes, but is not limited to, an independent game application program, and another application program that can provide a game function, such as a game mini program supported in a parent application program. The foregoing parent application program may be a social application program, an office application program, a shopping application program, a video playback application program, or the like. This is not limited in this application. For ease of understanding, in the embodiments of this application, an exemplary description is made by using an example in which the application program is a game application program. However, the technical solutions in the embodiments of this application may alternatively be applied to another application program other than the game application program.

Game types supported by the game application program include, but are not limited to, a massive multiplayer online role-playing game (MMORPG), a first person shooting (FPS) game, an adventure game (ATG), an action game (ACT), a simulation game (SLG), an open-world application program, a multiplayer party game, a versus game, and the like.

The game application program not only can support player VS environment (PVE), but also can support player VS player (PVP). This is not limited herein.

In an embodiment, a season mechanism is set in a game supported by the game application program. At the end of one season, virtual props obtained by a player in the season are settled and reset. The season mechanism set in the game may be maintained by the server 20.

The server 20 can provide a backend service for the application program run on the terminal device 10. For example, the server 20 may be a backend server of the application program. The server 20 may be an independent physical server, or may be a server cluster or distributed system including a plurality of physical servers, or may be a cloud server that provides basic cloud computing services such as a cloud service, cloud computing, a cloud function, cloud storage, a network service, cloud communication, a domain name service, and an artificial intelligence platform. The server 20 at least has data receiving and transmitting, data storage, and computing functions.

The terminal device 10 and the server 20 are connected to each other via a wired or wireless network.

In an example, running of the application program on the terminal device 10 relies on data provided by the server 20. The terminal device 10 generates a data request based on an operation performed by a user in an application program and transmits the data request to the server 20, and the server 20 provides corresponding data for the terminal device 10 based on the data request. Exemplarily, in an example of this application, a logic determination operation of determining a first season stage is performed by the server 20. After determining the first season stage from a plurality of season stages included in a season of the application program, the server 20 generates interface display data and transmits the interface display data to the terminal device 10. The terminal device 10 displays a season stage presentation interface in the application program based on the interface display data, and displays value prompt information related to the first season stage on the season stage presentation interface. For details of this operation, refer to the following embodiments.

In the related art, accumulation of a user in a season depends on game duration of the user in the season. With the continuous progress of the season, a strength difference between different users gradually increases due to different game duration. Users with different strength face different levels of difficulty in playing the same virtual object, which makes it difficult for them to play the same game together, and the difficulty of matching users for games on the server increases.

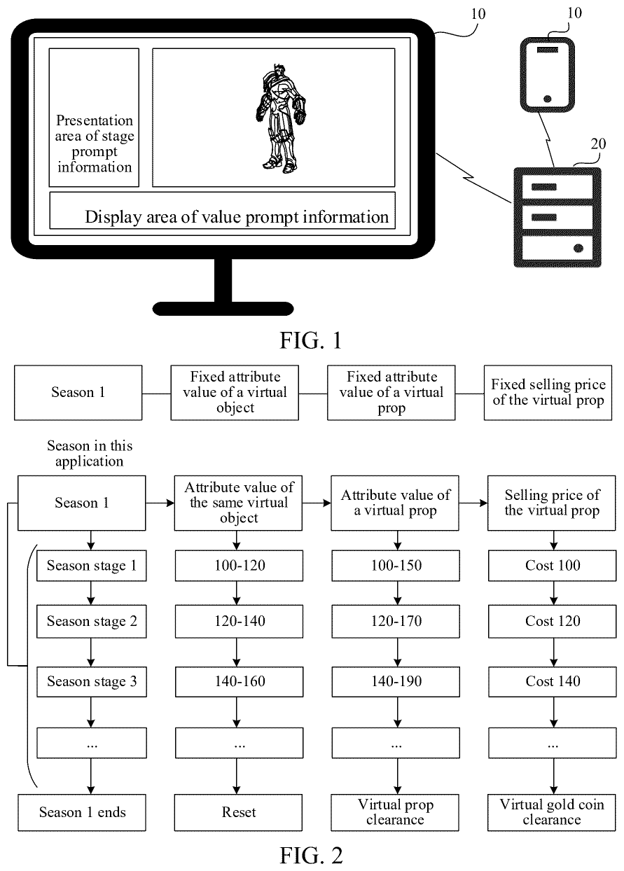

A game application program is taken as an example. As shown in FIG. 2, in the embodiments of this application, a complete season is divided into a plurality of different season stages, and corresponding value ranges are set for attribute values of virtual props and attribute values of virtual objects in the season stages, whereby the problem of an excessively large strength difference between different users caused by different game durations in the complete season is alleviated. By respectively setting the attribute values for the virtual props and the virtual objects in different season stages, the strength of different users is aligned as much as possible. Especially in a later stage of a game, this helps to reduce a case that different users cannot play a game together because they have a relatively large strength difference. Further, for a multiplayer game, a number of users that can be matched within a period of time is sufficient through this setting, which helps reduce the matching load on the server during game matching.

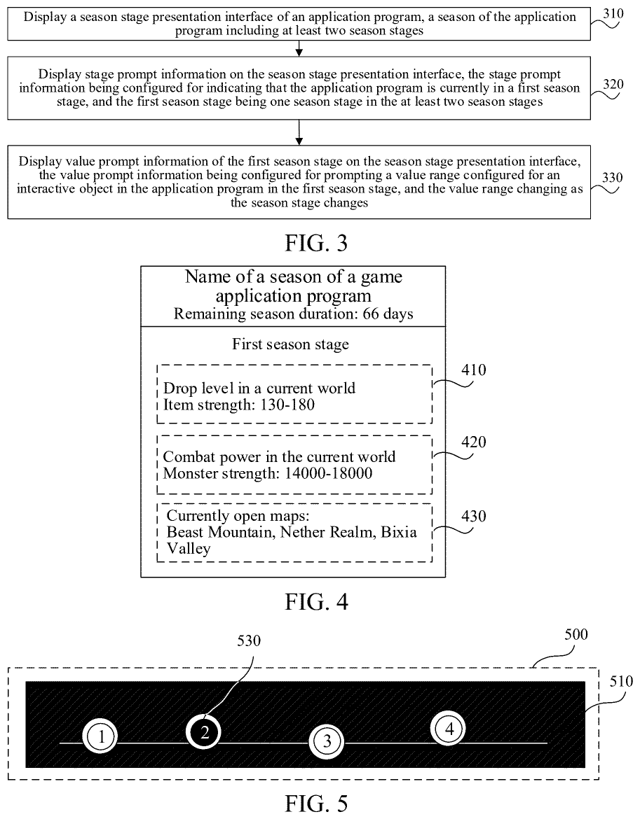

FIG. 3 is a flowchart of a season information presentation method according to an exemplary embodiment of this application. Exemplarily, an executive subject of the method may be the terminal device 10 in the solution implementation environment shown in FIG. 1. For example, the executive subject may be a client of a target application program run on the terminal device 10. As shown in FIG. 3, the method may include the following operations (310 to 330).

Operation 310: Display a season stage presentation interface of an application program, a season of the application program including a plurality of season stages.

In some embodiments, the application program can provide a season division function. Exemplarily, the application program may be a live streaming application program where a streamer performs different tasks during a season to advance in rank. Exemplarily, the application program may be a game application program. For ease of understanding, in the embodiments of this application, an exemplary description is made by using an example in which the application program is a game application program. However, the technical solutions in the embodiments of this application may alternatively be applied to another application program other than the game application program.

In some embodiments, the game application program is configured for providing a game for a user. In other words, the game application program is an application program designed to support running of a game. In an embodiment, the game supported in the game application program belongs to an online game, and a server provides game data support for the game application program on the terminal device. A plurality of users may participate in the same game via game application programs deployed in respective terminal devices.

In an embodiment, a type of the game application program includes, but is not limited to, at least one of the following: a game application program having an independent client, a web-type game application program, a mini program in a parent application program, and the like. The type of the game application program is not limited in this application.

In some embodiments, a season system is set for the game in the game application program. The season of the game application program is a period in which benefits obtained by a user from the game are accumulated in the game supported by the game application program. For example, in a season, benefits obtained by the user from the game are continuously accumulated, and after the season ends, the benefits obtained by the user in the season are settled and reset.

In an embodiment, the benefits obtained by the user from the game include, but are not limited to, a virtual prop, a virtual gold coin, and the like that are obtained by the user by controlling a user virtual object from a virtual environment. In the embodiments of this application, the season of the game application program refers to a current season when the terminal device runs the game application program. That is, the season of the game application program refers to an ongoing season.

In some embodiments, the season stage refers to a stage obtained by dividing a season period based on time. In some embodiments, the season of the game application program includes a plurality of season stages. In other words, in the embodiments of this application, a complete season is divided into a plurality of season stages, and the plurality of season stages do not overlap with each other in time period. In an embodiment, time period spans corresponding to different season stages may be the same, or may be different. This is not limited in this application. For example, a time span of one season is 60 days, and the season includes three season stages that are a season stage 1, a season stage 2, and a season stage 3, respectively. Time period spans respectively corresponding to different season stages are the same. In this case, the season stage 1 corresponds to the 1^{st} day to the 20^{th} day after the season starts, the season stage 2 corresponds to the 21^{st} day to the 40^{th} day after the season starts, and the season stage 3 corresponds to the 41^{st} day to the 60^{th} day after the season starts. Time period spans respectively corresponding to different season stages are different. In this case, the season stage 1 corresponds to the 1^{st} day to the 10^{th} day after the season starts, the season stage 2 corresponds to the 11^{th} day to the 40^{th} day after the season starts, and the season stage 3 corresponds to the 41^{st} day to the 60^{th} day after the season starts.

In an embodiment, virtual props and virtual gold coins that are obtained by the user in different season stages of the same season can be accumulated. When a plurality of season stages included in a season all end, the season ends, and benefits of the user in the season are settled and reset.

In some embodiments, a total number of season stages included in one season is dynamically set according to a game status of a user in the game application program. Exemplarily, the server determines a total number of season stages included in a subsequent season according to a strength difference between users in an ended season. The strength of the user is configured for representing an attribute value of a virtual object controlled by the user via a user account, namely, fighting strength of the user virtual object controlled by the user in the game. The strength difference between users may be understood as a difference between attribute values of user virtual objects respectively controlled by different users.

In view of an excessively large number of users in the game application program, the strength difference between the users may be calculated based on an average strength value of the users. Exemplarily, the server divides the users in the game application program into different strength intervals according to strength of the users. For any strength interval, the server calculates an average value of the strength interval, and takes the average value as a strength representative value of the strength interval. The server calculates a difference between strength representative values of a first strength interval and a second strength interval, to obtain the strength difference between the users. One of the first strength interval and the second strength interval includes a user with maximum strength, and the other strength interval includes a user with minimum strength.

For example, the server collects statistics on strength of a plurality of users whose difference in a game duration in an ended season is less than a duration threshold, divides the plurality of users into a plurality of strength intervals, and determines a strength difference between the users in the ended season based on the plurality of strength intervals.

If the strength difference between the users in the ended season is less than or equal to a preset strength difference, a total number of season stages included in the subsequent season is equal to a total number of season stages included in the ended season; or if the strength difference between the users in the ended season is greater than the preset strength difference, the total number of season stages included in the subsequent season is greater than the total number of season stages included in the ended season. In this case, the server re-divides the time periods corresponding to the season stages, to determine time periods respectively corresponding to the plurality of season stages included in the subsequent season. That is, in this case, the total number of season stages included in the subsequent season is increased compared with the total number of season stages included in the ended season.

In some embodiments, the season stage presentation interface is configured for presenting display content related to the season stage. For details of the display content on the season stage presentation interface, refer to the following embodiments.

In an embodiment, the terminal device automatically displays the season stage presentation interface of the game application program. For example, after the user of the terminal device starts the application program, the terminal device displays the season stage presentation interface. For another example, when the game application program is not loaded completely, the terminal device displays the season stage presentation interface. For another example, when the game application program is still waiting for matching to enter the game, the terminal device displays the season stage presentation interface.

Exemplarily, the terminal device determines whether a current moment is a display timing of the season stage presentation interface, and if the current moment is the display timing of the season stage presentation interface, the terminal device displays the season stage presentation interface, or if the current moment is not the display timing of the season stage presentation interface, the terminal device does not display the season stage presentation interface. For example, that the user starts the application program is the display timing of the season stage presentation interface, and the terminal device determines to display the season stage presentation interface at this moment. This manner helps reduce the interference of the season stage presentation interface with another display content in the game application program.

In an embodiment, the terminal device displays the season stage presentation interface of the game application program in response to an operation of displaying the season stage presentation interface. For example, a presentation control is set on a user interface of the game application program, and the terminal device displays the season stage presentation interface in response to an operation of triggering the presentation control. The operation of triggering the presentation control includes, but is not limited to, clicking/tapping, sliding, touching, long-pressing, button-pressing, gesture operation, and the like. The season stage presentation interface is displayed according to actual requirements. This is not defined in this application.

Operation 320: Display stage prompt information on the season stage presentation interface, the stage prompt information being configured for indicating that the application program is currently in a first season stage, and the first season stage being one season stage in the plurality of season stages.

In some embodiments, the first season stage refers to an ongoing season stage in the game application program. The first season stage may be any one of the plurality of season stages included in the season of the game application program. In an embodiment, which season stage in the plurality of season stages is the first season stage is determined according to a moment at which the terminal device displays the season stage presentation interface. That is, the first season stage changes with the change of the moment at which the terminal device displays the season stage presentation interface. If the moment at which the terminal device displays the season stage presentation interface is within a time period corresponding to a season stage, the season stage is the first season stage.

For example, the plurality of season stages includes a season stage 1, a season stage 2, a season stage 3, and a season stage 4. A time period corresponding to the season stage 1 is January 1 to January 5, a time period corresponding to the season stage 2 is January 6 to January 10, a time period corresponding to the season stage 3 is January 11 to January 15, and a time period corresponding to the season stage 4 is January 16 to January 20. The terminal device displays the season stage presentation interface on January 3, 12:00, and in this case, the first season stage is the season stage 1 in the plurality of season stages.

In an embodiment, the first season stage is determined according to a season progress, which is calculated by the server or the terminal device in real time. Exemplarily, the season progress is equal to a current moment minus a start time of the season, divided by the total duration of the season. After the season progress is determined, a season stage corresponding to the season progress is taken as the first season stage.

In some embodiments, the stage prompt information is configured for prompting a current season stage of the game application program. The current season stage is the first season stage. In an embodiment, a type of the stage prompt information includes, but is not limited to, at least one of the following: text information, a picture, a prompt icon, and the like. For example, the stage prompt information includes a name of the first season stage and a prompt icon of the first season stage. The type of the stage prompt information is determined according to actual requirements. This is not defined in this application.

Operation 330: Display value prompt information of the first season stage on the season stage presentation interface, the value prompt information being configured for prompting a value range configured for an interactive object in the application program in the first season stage, and the value range changing as the season stage changes.

The interactive object refers to an object that can generate an interaction effect in response to an interaction operation of a user in the game application program. The interactive object is displayed in a virtual environment provided by the game application program, and a process in which a user plays a game includes a process of interacting with the interactive object. The virtual object and the virtual prop that are mentioned in the foregoing embodiments both belong to the interactive object in the game application program.

In an embodiment, the interactive object is configured for carrying the plot development of the game, and may also affect the difficulty of the game. Exemplarily, functions of different types of interactive objects in the game are different, and interaction effects of interaction between the different types of interactive objects and the user are also different. The interactive object has an attribute, and an interaction effect of interaction between the interactive object and the user is related to the attribute of the interactive object.

In the embodiments provided in this application, attribute values of interactive objects of the same type in the plurality of season stages have different value ranges. The value prompt information on the season stage presentation interface is configured for prompting a value range configured for an interactive object in the game application program in the first season stage. As the season stage changes, the value range of the interactive object also changes.

The value prompt information of the first season stage is configured for prompting the game difficulty in the first season stage. The value prompt information of the first season stage helps the user learn about game difficulty and benefits in the first season stage.

In some embodiments, the value range of the interactive object in the first season stage is preset. That is, value prompt information of the plurality of season stages included in the season is preset. In an embodiment, the value prompt information of the plurality of season stages may be stored in the terminal device, or may be stored in the server. After a season stage starts, the terminal device obtains value prompt information preset for the season stage from a local storage space. Alternatively, after a season stage starts, the terminal device communicates with the server, to obtain value prompt information of the season stage.

In some other embodiments, the value range of the interactive object in the first season stage is dynamically set according to a user status in a historical season stage. For example, the value prompt information of the first season stage is determined according to game data of the historical season stage that is in the plurality of season stages and that has been completed.

A time period corresponding to the historical season stage is earlier than a time period corresponding to the first season stage. That is, the historical season stage refers to a season stage that has been ended in an ongoing season. For example, the historical season stage refers to a season stage that just ends before the first season stage starts.

The game data is configured for reflecting a game status of the user in the historical season stage. Exemplarily, the game data includes at least one of the following: game duration of the user in the historical season stage and user strength at the end of the historical season stage.

In an embodiment, the value prompt information is determined by the server according to a strength difference between different user and game duration in the historical season stage. If the strength difference between the users is greater than a preset strength threshold, a first value is added to an upper limit value of a value range corresponding to the historical season stage, to obtain an upper limit value of a value range corresponding to the first season stage; and a second value is added to a lower limit value of the value range corresponding to the historical season stage, to obtain a lower limit value of the value range corresponding to the first season stage.

Exemplarily, the first value and the second value are preset, or the first value and the second value are determined according to the game duration of the user in the historical season stage. For example, first value-first benchmark value*strength difference between users/game duration difference, where the first benchmark value is a fixed positive integer, and the game duration difference is configured for representing a difference in duration for which different exemplary users play the game in the historical season stage. For another example, second value=second benchmark value*strength difference between users/game duration difference, where the second benchmark value is a fixed positive integer.

In the embodiments of this application, the value prompt information of the first season stage is different from value prompt information of other season stages in the plurality of season stages. That is, as the season stage changes, the interaction effect of interaction with the interactive object in the game application program changes, and an attribute change of the interactive object is related to a current season stage. In an embodiment, the season stages correspond to different value ranges. Exemplary, value ranges respectively corresponding to different season stages do not overlap. That is, for the same interactive object, attributes of the interactive object are different in different season stages, and interaction effects of interaction with the interactive object are different in different season stages.

For example, for two season stages that are adjacent in time sequence in a season, an upper limit value of a value range (for example, the value range is 121 to 140) in a season stage that is earlier in time sequence is less than a lower limit value of a value range (for example, the value range is 141 to 160) in a season stage that is later in time sequence.

In an embodiment, in different season stages of the same season, there is a rule in a change trend of the value prompt information. Exemplarily, as the season stage evolves, the value range in the value prompt information gradually increases. For details of this operation, refer to the following embodiments.

An execution sequence of operation 320 and operation 330 is not limited in this application. Operation 320 may be first performed and then operation 330 is performed, or operation 330 may be first performed and then operation 320 is performed. Alternatively, Operation 320 and operation 330 may be performed simultaneously. In an example, when the season stage presentation interface is displayed, the season stage presentation interface displays the stage prompt information and the value prompt information of the first season stage. In another example, after displaying the season stage presentation interface, the terminal device displays the stage prompt information and the value prompt information of the first season stage on the season stage presentation interface in response to an operation of displaying the prompt information.

In some embodiments, the season stage presentation process is jointly participated by a terminal device and a server, and may specifically include the following several operations. Operation A10: The terminal device transmits a data request to the server, the data request being configured for obtaining interface display data related to the season stage presentation interface. Operation A20: The server determines a first season stage from a plurality of season stages included in a current season according to the data request. The server generates the interface display data according to the first season stage and transmits the interface display data to the terminal device. In an embodiment, the interface display data includes identification information of the first season stage and value prompt information of the first season stage. Operation A30: The terminal device displays the season stage presentation interface of an application program. Operation A40: The terminal device displays stage prompt information on the season stage presentation interface according to the interface display data, to prompt that a current season stage is the first season stage. Operation A50: The terminal device displays the value prompt information of the first season stage on the season stage presentation interface according to the interface display data.

In conclusion, a complete season is divided into a plurality of different season stages, and attribute values of virtual props and attribute values of virtual objects in the season stages are differently set, whereby the problem of an excessively large strength difference between different users in the same season caused by different game duration is alleviated. The season stage presentation interface is set in the game application program, and the attribute value range of the virtual object and the attribute value range of the virtual prop that are related to the current season stage are presented on the season stage presentation interface. In this way, a user can clearly perceive changes of the attribute value of the virtual object and the attribute value of the virtual prop in different season stages, and visibility of the change of the season stage is enhanced.

In addition, this manner helps to align strength of different users in the same season, to reduce a strength difference between the different users. This allows each user to be free from strength constraints in the season and experience as much scene content as possible, and enhances the play rate of game content. For a backend server supporting a game application program, this mechanism reduces a strength difference between users and increases a number of candidate users that can be matched in the same time period. Therefore, the server can quickly perform user matching, matching logic of the server is simplified, game matching efficiency is enhanced, and waiting time of a user is reduced.

The following describes an interactive object in an application program and how value prompt information affects the interactive object.

In some embodiments, the interactive object includes at least one of the following: a virtual object and a virtual prop. The value prompt information includes at least one of first value prompt information and second value prompt information. The first value prompt information is configured for prompting a first value range configured for an attribute of a virtual object in a first season stage, and the second value prompt information is configured for prompting a second value range configured for the attribute of the virtual prop in the first season stage.

The virtual object in the game application program includes at least one of the following: a non-player character (NPC) and a user virtual object controlled by a user via a user account. In the embodiments of this application, the NPC is also referred to as a monster virtual object.

In an embodiment, the value prompt information of the first season stage includes at least one of first value prompt information and second value prompt information. For example, the value prompt information of the first season stage includes the first value prompt information. For another example, the value prompt information of the first season stage includes the second value prompt information. For another example, the value prompt information of the first season stage includes the first value prompt information and the second value prompt information.

In some embodiments, the attribute of the virtual object is configured for representing an interaction effect of interaction between the virtual object and another virtual object in a virtual environment in a game. The another virtual object includes at least one of the following: a monster virtual object and a user virtual object controlled by another user via a user account. The attribute of the virtual object may be represented by an attribute value of the virtual object.

The first value prompt information is configured for prompting a first value range configured for the attribute of the virtual object in the first season stage. That is, in the first season stage, the attribute of the virtual object is determined according to the first value range. In the first season stage, the attribute value of the virtual object in the application program is restricted by the first value range. Exemplarily, in the first season stage, the attribute value of the virtual object falls within the first value range. Exemplarily, the attribute value of the virtual object fluctuates based on the upper limit value of the first value range.

In an embodiment, a value range configured for an attribute of a monster virtual object may be the same as or different from a value range configured for an attribute of the user virtual object. For example, the first value prompt information includes the value range configured for the attribute of the user virtual object and the value range configured for the attribute of the monster virtual object.

In some embodiments, the virtual prop is a usable prop provided in the game application program. The virtual prop is configured for enhancing fighting power of a virtual object, or the virtual prop acts on a virtual object, to control behaviors of the virtual object in a virtual environment. The attribute of the virtual prop is configured for measuring a value of the virtual prop obtained in the first season stage. The virtual prop includes, but is not limited to, an equipment prop, a costume, a consumable, and the like that can be picked up in the virtual environment. For example, when a user controls a user virtual object to achieve a game goal, a pickable virtual prop appears in the virtual environment. The virtual prop may alternatively be sold or purchased in an online store in the game application program. The attribute of the virtual prop may be represented by an attribute value of the virtual prop.

The second value prompt information is configured for prompting a second value range configured for the attribute of the virtual prop in the first season stage. That is, in the first season stage, the attribute of the virtual object is determined according to the second value range. Exemplarily, in the first season stage, the attribute value of the virtual prop falls within the second value range. Exemplarily, the attribute value of the virtual prop fluctuates based on the upper limit value of the second value range. For example, the attribute value of the virtual prop in the first season stage is not less than the lower limit value of the second value range.

In an embodiment, the first value prompt information and the second value prompt information are preset. Exemplarily, change rules of the first value prompt information and the second value prompt information are the same. It is assumed that the season in the game application program includes a first season stage and a second season stage, if a first value range in the first season stage is less than a first value range in the second season stage, a second value range in the first season stage is less than a second value range in the second season stage.

For a method for determining specific value ranges respectively corresponding to the first value prompt information and the second value prompt information that are included in the value prompt information of the first season stage, refer to the foregoing embodiments. This is not limited in this application.

In an embodiment, in different season stages of the same season, types of monster virtual objects and virtual props that appear are different. That is, a monster virtual object appearing in a season stage may not appear in another season stage; and a virtual prop in a season stage may not be obtained in another season stage. With the continuous progress of the season, strength of a user gradually increases. Monster virtual objects and virtual props are replaced in different season stages, which helps balance the game difficulty and the strength of the user. Meanwhile, in different season stages, the server may maintain only the monster virtual object and the virtual prop in the season stage, which helps reduce load on the server.

Exemplarily, different monster virtual objects refer to monster virtual objects with different attributes, and forms of the monster virtual objects in different season stages may be the same or may be different. For example, the attribute values of the monster virtual objects in different season stages are different, but the monster virtual objects may be represented by using the same or similar texture map or three-dimensional model. In this manner, the game application program in the terminal device does not need to be frequently updated when the season stage changes, and monster virtual objects with different attributes can also be implemented in different season stages, which helps reduce update and maintenance costs of the game application program.

According to foregoing method, the attribute of the virtual object is prompted based on the first value prompt information, and an attribute of the virtual prop is prompted based on the second value prompt information, which helps a user determine a game goal that the user can complete in the first season stage. In this way, the user can better plan a game progress based on the value prompt information. In addition, different value ranges are configured for the attributes of the interactive objects in different season stages, which helps align strength of different users in the same season, and reduces a strength difference between different users.

In some embodiments, the attribute of the virtual object includes at least one of the following: a capability of the virtual object and a benefit of the virtual object. The capability of the virtual object gradually increases with the progress of the season stage, and the benefit of the virtual object gradually increases with the progress of the season stage. The attribute of the virtual prop includes at least one of the following: a capability of the virtual prop and a value of the virtual prop. The capability of the virtual prop gradually increases with the progress of the season stage, and the value of the virtual prop gradually increases with the progress of the season stage.

In some embodiments, the progress of the season stage refers to a season progress of the season. In the embodiments of this application, the season progress of the season is represented by the season stage. Different season stages correspond to different season progress within the season. In an embodiment, the attribute of the virtual object continuously increases as the season progress advances, and the attribute of the virtual prop continuously increases as the season progress advances. In other words, with the continuous progress of the season stage, game difficulty continuously increases, and game gains obtained from the game also continuously increase.

In some embodiments, the capability of the virtual object is configured for representing an interaction effect of an interaction of the virtual object with another virtual object in the game. The another virtual object includes at least one of the following: a user virtual object controlled by another user and a monster virtual object. In an embodiment, the interaction of the virtual object with the another virtual object in the game includes, but is not limited to, attacking the other virtual object, being attacked by the another virtual object, obtaining help from the another virtual object, and providing help to the another virtual object.

In an embodiment, the capability of the virtual object includes, but is not limited to, at least one of the following: attack power, health points, magic points, defense value, healing output, and the like of the virtual object. Exemplarily, the capability of the virtual object is related to a virtual prop equipped by the virtual object. For example, the capability of the virtual object is in positively correlated with an attribute value of the virtual prop equipped by the virtual object. The capability of the virtual object is also referred to as fighting strength or the like of the virtual object.

In some embodiments, the benefit of the virtual object is configured for representing a game reward obtained by the virtual object in the game. In an embodiment, the benefit of the virtual object includes a benefit obtained by a user virtual object from eliminating another virtual object. Exemplarily, the benefit of the virtual object includes at least one of the following: a pickable prop dropped in a game, a virtual gold coin obtained by eliminating another virtual object, and the like.

In some embodiments, the capability of the virtual prop is configured for representing a gain brought to the attribute of the virtual object after the virtual prop is used. In an embodiment, the capability of the virtual prop includes, but is not limited to, at least one of the following: an attack gain, a defense gain, a magic gain, a health point gain, and the like. The capability of the virtual prop is also referred to as strength of the virtual prop, fighting strength of the virtual prop, or the like. In an embodiment, the capability of the virtual prop continuously increases with the progress of the season stage.

In some embodiments, the value of the virtual prop refers to a number of virtual gold coins exchangeable for the virtual prop. In an embodiment, the value of the virtual prop continuously increases with the progress of the season stage. The virtual prop may be redeemed in an online store of the game application program, or may be directly exchanged for virtual gold coins on a settlement page of the game after a round of the game ends.

In an example, the value prompt information of the first season stage includes: first value prompt information and second value prompt information. The first value prompt information includes a value range of a capability of a virtual object in the first season stage; and the second value prompt information includes a value range of a capability of a virtual prop in the first season stage.

In an embodiment, the value prompt information of the first season stage further includes an open-world range. An open world refers to an activity area that can be reached in a virtual environment provided by the game application program. That is, the open world is a local virtual environment accessible to users through various movement operations. Exemplarily, the virtual environment is a simulated environment of the real world, a semi-simulated and semi-fictional environment, or a completely fictional environment. The virtual environment may be any one of a two-dimensional virtual environment, a 2.5-dimensional virtual environment, and a three-dimensional virtual environment. This is not limited in this application. Exemplarily, the user controls the user virtual object to move in the virtual environment and perform an interaction operation.

FIG. 4 is a schematic diagram of a display style of value prompt information according to an exemplary embodiment of this application. As shown in FIG. 4, display content of the value prompt information includes: first value prompt information 420, second value prompt information 410, and an open-world range 430.

By setting a capability of a virtual prop to gradually increase with the progress of a season stage, and a value of the virtual prop to gradually increase with the progress of the season stage, a function and a value of a virtual prop obtained in a season stage dynamically decay in a subsequent season stage. This mechanism helps reduce user addiction to games and prevents malicious game studios from repeatedly farming virtual props for profit, and helps increase the fairness and playability of games in game application programs.

The following introduces and describes a display method of a season stage presentation interface with reference to several embodiments.

In some embodiments, operation 310 that a season stage presentation interface of an application program is displayed may include the following several sub-operations. An executive subject of the several sub-operations is a terminal device.

Sub-operation 313: Obtain an interface display instruction in response to an interface display operation obtained in a first season stage, the interface display instruction being configured for indicating a display timing of a season stage presentation interface.

In some embodiments, display of the season stage presentation interface is triggered by a user operation. In an embodiment, the interface display operation obtained in the first season stage includes an operation of logging in to a game application program by a user. For example, the terminal device displays the season stage presentation interface in the game application program in response to the operation of logging in to the game application program.

In an embodiment, a presentation control is set on a user interface of the game application program, and the interface display operation obtained in the first season stage includes a trigger operation for the presentation control. For example, the trigger operation for the presentation control refers to clicking the presentation control, and the terminal device displays the season stage presentation interface in the game application program in response to the operation of clicking the presentation control. A type of the interface display operation obtained in the first season stage is set according to actual requirements. This is not limited in this application.

Exemplarily, whether the season stage presentation interface is displayed is indicated by the server. The terminal device generates a display request and transmits the display request to the server in response to the interface display operation obtained in the first season stage. The display request at least includes: a moment at which the interface display operation is obtained and identification information of a first user account logged in to the game application program. The server generates the interface display instruction according to the display request and transmits the interface display instruction to the terminal device. The interface display instruction is configured for instructing the terminal device whether to display the season stage presentation interface.

Sub-operation 316: If a first user account logged in to the application program satisfies a prompt information presentation condition, display the season stage presentation interface according to the interface display instruction, the prompt information presentation condition including at least one of the following: the application program being within a season period of a season, a login count of the first user account within a first time period being less than or equal to a threshold, and the first user account being in a state of waiting to join a scene, the first time period referring to a period of time within the first season stage.

In some embodiments, the prompt information presentation condition is configured for determining the display timing of the season stage presentation interface. In an embodiment, after receiving a presentation request, the server first determines whether the presentation request satisfies the prompt information presentation condition. If the presentation request satisfies the prompt information presentation condition, the server generates interface display data and transmits the interface display data to the terminal device; or if the presentation request does not satisfy the prompt information presentation condition, the server does not generate interface display data or generates invalid interface display data. The invalid interface display data is configured for indicating that the season stage presentation interface does not need to be displayed.

In some embodiments, the prompt information presentation condition includes at least one of or a combination of at least two of: a login count of the first user account within a first time period being less than or equal to a threshold, the first user account being in a state of waiting to join a scene (such as a game scene), and whether a current moment is within a season period of a season.

In an embodiment, the season period of the season refers to an ongoing stage of a season in which the game application program is currently running. When the prompt information presentation condition includes whether a current moment is within a season period of a season, if the current moment is within the season period of the season, the presentation request satisfies the prompt information presentation condition; or if the current moment is not within a season period of a season, that is, there is no ongoing season in the game application program at the current moment, it is determined that the display request does not satisfy the prompt information presentation condition, and the season stage presentation interface does not need to be displayed.

In an embodiment, the first time period indicates a time interval at which a presentation count of the season stage presentation interface is refreshed. For example, the first time period is one natural day. The threshold may be preset as a positive integer, for example, the threshold is equal to 1. When the prompt information presentation condition includes that the login count of the first user account within the first time period is less than or equal to the threshold, if a login count of the first user account within one natural day is less than or equal to the threshold, the presentation request satisfies the prompt information presentation condition.

In an embodiment, the state of waiting to join a game is configured for representing that the first user account is currently playing a game. The first user account refers to an account used by a user to log in to the game application program. When the prompt information presentation condition includes whether the first user account is in a state of waiting to join a game, if the first user account is in the state of waiting to join a game, the presentation request satisfies the prompt information presentation condition.

In an example, the prompt information presentation condition includes: a login count of the first user account within a first time period is less than or equal to a threshold, and whether a current moment is within a season period of a season. If the current moment is in a season period of a season, and the login account of the first user account within the first time period is less than or equal to the threshold, the season stage presentation interface needs to be displayed, to display stage prompt information and value prompt information of a current stage in the season stage display.

The display timing of the season stage presentation interface is determined, and the season stage presentation interface is displayed in the game application program only when the obtained interface display operation satisfies the prompt information presentation condition, which helps find an appropriate presentation timing of the season stage presentation interface, to control a display count of the season stage presentation interface. In this way, obstruction of another display content in the game application program caused by displaying the season stage presentation interface is reduced.

The following introduces and describes a display form of stage prompt information on a season stage presentation interface with reference to several embodiments.

In some embodiments, operation 320 that the stage prompt information is displayed on the season stage presentation interface may include the following several sub-operations. An executive subject of the following several sub-operations is a terminal device.

Sub-operation 323: Obtain interface display data transmitted by a server, the interface display data being configured for indicating display content on a season stage presentation interface.

In an embodiment, the interface display data at least includes identification information of a first season stage. The identification information of the first season stage is configured for uniquely identifying the first season stage. Exemplarily, the identification information of the first season stage includes, but is not limited to, a name, a number, a prompt icon, and the like of the first season stage.

In an embodiment, the interface display data further includes value prompt information of the first season stage. The terminal device can determine first value prompt information and second value prompt information that are in the first season stage based on the value prompt information in the interface display data.

In an example, to reduce a transmission bandwidth consumed by transmission of interface presentation data and enhance efficiency of obtaining the interface display data, the first season stage is identified by using a number. Correspondingly, the terminal device stores a table of a mapping relationship between a plurality of season stages and numbers. In this way, after receiving the interface display data, the terminal device determines the first season stage from the plurality of season stages according to the number of the first season stage.

Sub-operation 326: Display stage prompt information in a first display area of the season stage presentation interface according to the interface display data, the first display area referring to a partial area of the season stage presentation interface.

The first display area is a partial area of the season stage presentation interface. In an embodiment, the first display area refers to an area, configured for displaying the stage prompt information, of the season stage presentation interface. Other display content on the season stage presentation interface, such as value prompt information of the first season stage, is not displayed in the first display area. Exemplarily, the first display area is a regular geometrical area. For example, the first display area is a rectangular area at a lower section of the season stage presentation interface. A display shape of the first display area is set according to actual requirements. This is not defined in this application.

Because there may be a relatively large amount of display content on the season stage presentation interface, the stage prompt information is displayed in a separated display area of the season stage presentation interface, which enhances display conspicuity of the stage prompt information.

In some embodiments, the stage prompt information is indicated by using a prompt icon. In an embodiment, for different season stages of the same season, display styles of prompt icons of the season stages are different.

Sub-operation 326 may be implemented by using the following several sub-operations. An executive subject of the following several sub-operations is a terminal device.

Sub-operation 326-a: Obtain a display material from a resource package of an application program according to interface display data, the display material including a background picture of an ongoing season and a prompt icon of a first season stage.

In some embodiments, a game application program includes a resource package, and the resource package includes at least one art resource for displaying on a user interface of the game application program. That is, the resource package includes display materials in different season stages. In an embodiment, the resource package is updated in each season, to reduce a data volume of the resource package and enhance visual freshness of the season stage presentation interface in different seasons. This helps enhance user experience brought by the game application program to a user.

Sub-operation 326-b: Display the background picture in a first display area.

For example, a size of the first display area is less than or equal to a size of the background picture, and the terminal device displays the background picture in the first display area.

Sub-operation 326-c: Display the prompt icon of the first season stage on the top of the background picture.

In an embodiment, if the display material includes another season stage other than the first season stage in the plurality of season stages, the terminal device displays the prompt icon of the first season stage in a first form on the top of the background picture, and displays a prompt icon of the another season stage in a second form on the top of the background picture. The first form and the second form refer to two different display forms.

Exemplarily, an expression form of the display form includes at least one of the following: a display size of the prompt icon, a display color of the prompt icon, a display special effect of the prompt icon, identification text of the prompt icon, and the like. For example, a display color of the prompt icon of the first season stage is different from a display color of the prompt icon of another season stage. For another example, the prompt icon of the first season stage has a display special effect (highlighting the prompt icon of the first season stage).

FIG. 5 is a schematic diagram of an effect of a first display area according to an exemplary embodiment of this application. As shown in FIG. 5, a background picture 510 and a prompt icon 530 of a first season stage are displayed in a first display area 500.

In an example, a terminal device obtains interface display data from a server. In an embodiment, the interface display data includes a number of the first season stage. The terminal device determines that the number of the first season stage corresponds to the first season stage according to a mapping table of season stages and numbers. The terminal device determines a background picture of a season from a material package and prompt icons of season stages of the season. Subsequently, the terminal device displays the background picture in the first display area of the season stage presentation interface, and displays the season icons of the season stages on the top of the background picture. The prompt icon of the first season stage is displayed in a lighted form, and prompt icons of other season stages are displayed in an unlighted form.

In this manner, a current season stage is prompted in a particular display area in a visual form, whereby a presentation effect of the current season stage is more intuitive. This helps enhance a prompt effect of the season stage presentation interface for the current season.

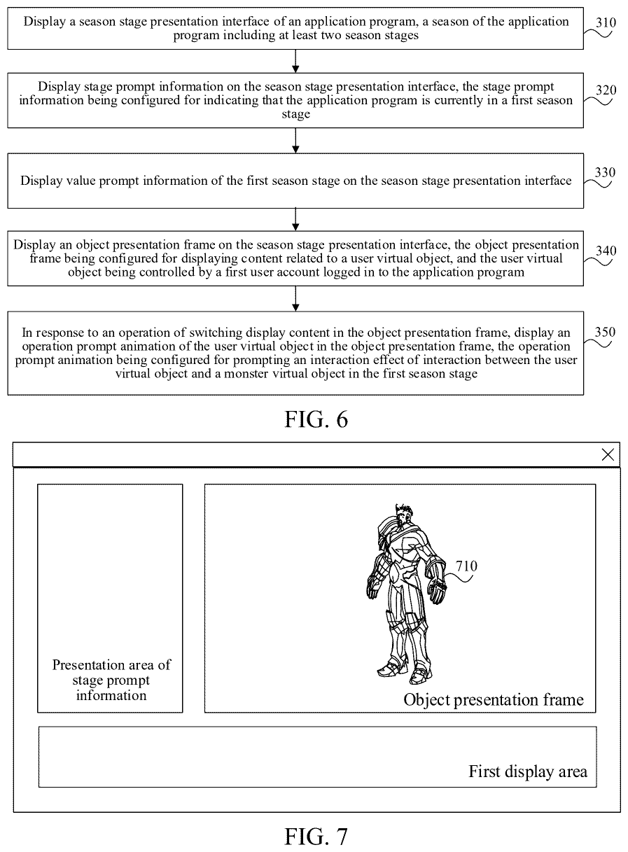

FIG. 6 is a schematic diagram of a season stage presentation method according to another exemplary embodiment of this application. As shown in FIG. 6, the season stage presentation method may include the following several operations. An executive subject of the following several operations is a terminal device.

Operation 310: Display a season stage presentation interface of an application program, a season of the application program including a plurality of season stages.

Operation 320: Display stage prompt information on the season stage presentation interface, the stage prompt information being configured for indicating that the application program is currently in a first season stage.

Operation 330: Display value prompt information of the first season stage on the season stage presentation interface.

For specific content of operation 310, operation 320, and operation 330, refer to the foregoing embodiments. Details are not described again here.

Operation 340: Display an object presentation frame on the season stage presentation interface, the object presentation frame being configured for displaying content related to a user virtual object, and the user virtual object being controlled by a first user account logged in to the application program.

In some embodiments, the user virtual object refers to a virtual character played by a user in a game, namely, a user virtual object controlled by the user via a user account. The virtual character and the virtual object have the same meaning in the embodiments of this application. In an embodiment, the game application program provides a plurality of selectable virtual objects for the user, and the user selects one virtual object from the plurality of selectable virtual objects as the user virtual object according to personal preference.

In an embodiment, presentation content in the object presentation frame is related to a user account logged in to a game application program. For different user accounts, display content in the object presentation frame on the season stage presentation interface is different. The first user account may be any user account logged in to the game user program, and the first user account is logged in to the game application program of the terminal device.

In an embodiment, the user virtual object in the object presentation frame refers to a three-dimensional model of the user virtual object in a virtual environment. Exemplarily, when the user virtual object is displayed in the object presentation frame, the terminal device rotates the user virtual object by taking a vertical center line of the three-dimensional model of the user virtual object as an axis in response to an operation of adjusting a display angle. For example, the operation of adjusting a display angle is a horizontal sliding operation sensed in an area of the object presentation frame, and a sliding direction of the horizontal sliding operation determines a rotation direction of the three-dimensional model of the user virtual object.

In an embodiment, a virtual prop equipped by the user virtual object is further displayed in the object presentation frame. That is, the three-dimensional model displayed in the object presentation frame is a three-dimensional model of the user virtual object superimposed with the virtual prop.

There is no strict execution time sequence of operation 320, operation 330, and operation 340. The execution time sequence of operation 320, operation 330, and operation 340 is not limited in this application. Exemplarily, when the terminal device displays the season stage presentation interface, the stage prompt information, the value prompt information of the first season stage, and the display content in the object presentation frame are simultaneously displayed on the season stage presentation interface.

FIG. 7 is a diagram of an effect of a season stage presentation interface according to an exemplary embodiment of this application.

As shown in FIG. 7, a user virtual object 710 is displayed in an object presentation frame on the season stage presentation interface. For display content in another display area, refer to the above introduction. Details are not described again here.

In some embodiments, display content in the object presentation frame may be switched. In an embodiment, the terminal device switches the display content in the object presentation frame according to a user instruction.

Operation 350: In response to an operation of switching display content in the object presentation frame, display an operation prompt animation of the user virtual object in the object presentation frame, the operation prompt animation being configured for prompting an interaction effect of interaction between the user virtual object and an interactive object in the first season stage.

The operation of switching display content in the object presentation frame is configured for adjusting the display content in the object presentation frame. In an embodiment, the operation of switching display content in the object presentation frame includes, but is not limited to, a click/tap operation, a slide operation, a button-press operation, a long-press operation, a double-click operation, and the like.

Exemplarily, a switch control is displayed on the season stage presentation interface, the operation of switching display content in the object presentation frame is a click operation for the switch control, and the terminal device switches the display content in the object presentation frame in response to the click operation for the switch control.

Exemplarily, the operation of switching display content in the object presentation frame is a non-horizontal sliding operation performed within the object presentation frame, and the terminal device switches the display content in the object presentation frame in response to the non-horizontal sliding operation sensed within the object presentation frame.

In some embodiments, the display content in the object presentation frame includes at least one of the following: a user virtual object controlled by the first user account and an operation prompt animation of the user virtual object. In an embodiment, the terminal device cancels displaying the three-dimensional model of the user virtual object in the object presentation frame in response to the operation of switching display content in the object presentation frame, and displays the operation prompt animation of the user virtual object. In an embodiment, the terminal device cancels displaying the operation prompt animation of the user virtual object in the object presentation frame in response to the operation of switching display content in the object presentation frame, and displays the three-dimensional model of the user virtual object.

In some embodiments, the operation prompt animation of the user virtual object is configured for representing an interaction effect of the user virtual object in the first season stage. In an embodiment, the operation prompt animation of the user virtual object includes the user virtual object controlled by the first user account and an interactive object appearing in the first season stage. In an embodiment, the interactive object is a monster virtual object in the game application program. That is, the operation prompt animation of the user virtual object includes the user virtual object and a first monster virtual object. An attribute value of the first monster virtual object falls within a first value range. The first value range refers to a value range that is related to the monster virtual object and that is included in the value ranges indicated by the value prompt information of the first season stage.

Exemplarily, the first monster virtual object refers to a monster virtual object that appears most frequently in the first season stage. Exemplarily, the first monster virtual object refers to a virtual object whose attribute value matches an attribute value of the user virtual object. For example, a difference between the attribute value of the first monster virtual object and the attribute value of the user virtual object is less than or equal to a preset value threshold.

In some embodiments, the operation prompt animation is pre-generated. In an embodiment, the operation prompt animation is generated according to the attribute value of the user virtual object and the attribute value of the monster virtual object. Exemplarily, before the first season stage starts, all user virtual objects in the game application program are grouped according to attribute values, to obtain a plurality of user virtual object groups, each user virtual object group corresponds to one attribute value interval, an attribute value of each user virtual object included in the user virtual object group belongs to the attribute value interval, and the attribute value intervals corresponding to different user virtual object groups do not overlap. For each user virtual object group in the plurality of user virtual object groups, the server generates an operation prompt animation of the user virtual object group. That is, user virtual objects included in the same user virtual object group share the same operation prompt animation, whereby generation load of the operation prompt animation and space resources occupied by storage of the operation prompt animation are reduced.

In an example, for a user virtual object group, the server determines a monster virtual object whose attribute data matches an attribute value interval corresponding to the user virtual object group, and takes the monster virtual object as the first monster virtual object. The server calculates interaction effects of various interaction behaviors performed by a target user virtual objects included in the user virtual object group on the first monster virtual object, and combines the interaction effects, to obtain an operation prompt animation of each user virtual object in the user virtual object group.

Exemplarily, an attribute value of the target user virtual object belongs to an intermediate value in the attribute value interval of the user virtual object group. The interaction effect of the interaction behavior includes, but is not limited to, an interaction action in a process in which the target virtual object performs the interaction behavior, and an effect of the interaction behavior on the first monster virtual object (including but not limited to at least one of the following: a change in health points, a paralyzing effect caused, and an effect of repelling the first monster virtual object). Exemplarily, the operation prompt effect is an interaction effect set of various interaction operations performed by the user virtual object on the first monster virtual object in the first season stage.

In an embodiment, the operation prompt animation is from an operation video uploaded by another user virtual object in the game application program.

In some embodiments, the terminal device generates an animation obtaining request and transmits the animation obtaining request to the server in response to the operation of switching display content in the object presentation frame. The server transmits a transmission bit-stream of an operation prompt animation to the terminal device according to the animation obtaining request. The terminal device decodes the transmission bit-stream to obtain the operation prompt animation, and displays the operation prompt animation in the object presentation frame. The animation obtaining request includes at least one of the following: identification information of the first user account, an attribute value of the first virtual object controlled by the first user account, and the like.

In some other embodiments, the terminal device obtains the operation prompt animation from a local storage space of the terminal device in response to the operation of switching display content in the object presentation frame, and displays the operation prompt animation in the object presentation frame. The interaction prompt animation is pre-stored in the terminal device, which helps accelerate response of the terminal device to the operation of switching display content in the object presentation frame.

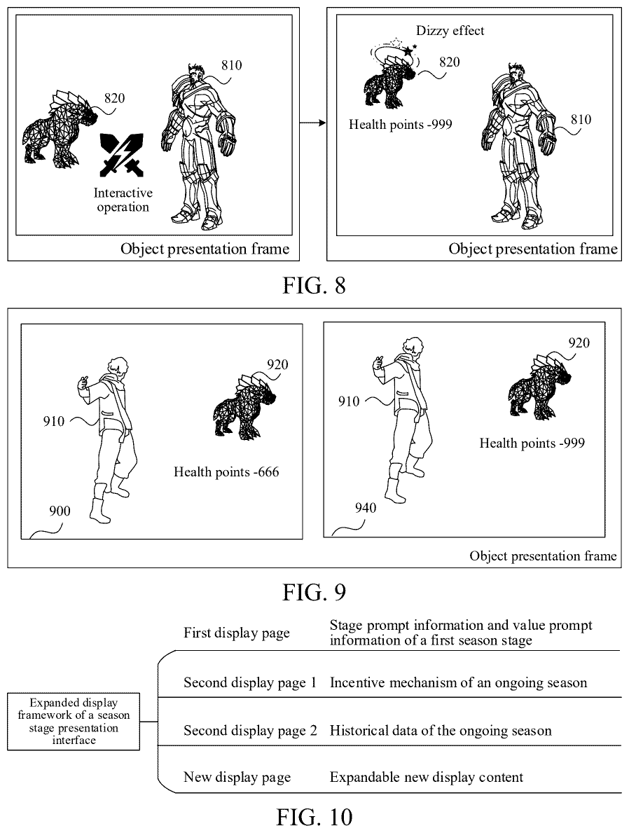

FIG. 8 is a diagram of an effect of displaying an operation prompt animation in an object presentation frame according to an exemplary embodiment of this application.

As shown in FIG. 8, in the object presentation frame, a user virtual object 810 performs an interaction operation on a monster virtual object 820, and then an interaction effect of the interaction operation is displayed in the object presentation frame.

In this embodiment, by presenting an operation prompt animation in the object presentation frame, a user can intuitively perceive a change of an attribute value of a monster virtual object in a current season stage, and reference information can be provided for the user to formulate operation strategies. In this manner, the occurrence of game failures and repeated restarts caused by unawareness of a season stage change can be reduced, settlement load on the server can be reduced, and game experience of the user can be enhanced.

To more clearly represent changes of an attribute value of a virtual object in different season stages of the same season, particularly, to help a user logging in for the first time in a first season stage understand a change occurring in the season stage, the object presentation frame can display a comparison prompt animation.

In some embodiments, the method shown in FIG. 6 further includes: operation 360 (not shown in the drawings of the specification): The terminal device displays a comparison prompt animation of the user virtual object in the object presentation frame in response to an operation of switching display content in the object presentation frame, the comparison prompt animation being configured for prompting an interaction effect of interaction between the user virtual object and an interactive object in a historical season stage, and the historical season stage referring to a completed season stage in the plurality of season stages.

In some embodiments, a historical interaction effect is configured for representing an interaction effect of interaction between a user virtual object and a monster virtual object in an ended season stage in the same season. In an embodiment, interactive objects appearing in the operation prompt animation and the comparison prompt animation may be the same or may be different. Exemplarily, the interactive object appearing in the operation prompt animation and the comparison prompt animation are the same, and are first monster virtual objects, and an attribute value of the first monster virtual object in the operation prompt animation is different from an attribute value of the first virtual object in the comparison prompt animation.

Exemplarily, the interactive objects appearing in the operation prompt animation and the comparison prompt animation are different. For example, the interactive object in the operation prompt animation is a monster virtual object appearing most frequently in the first season stage, and the interactive object in the comparison prompt animation is a monster virtual object appearing most frequently in the historical season stage. In this case, forms of the interactive objects in the operation prompt animation and the comparison prompt animation are different.

In some embodiments, if a login count of the first user account in the first season stage is less than or equal to a login count threshold, the terminal device displays the comparison prompt animation of the user virtual object and a stage prompt animation of the user virtual object in the object presentation frame in response to the operation of switching display content in the object presentation frame. If the login count of the first user account in the first season stage is greater than the login count threshold, the terminal device displays the stage prompt animation of the user virtual object in the object presentation frame in response to the operation of switching display content in the object presentation frame. The login count threshold may be preset.

According to this method, the comparison prompt animation and the operation prompt animation are displayed in an early stage of participation of the user in the current season stage, whereby the change of the attribute value of the virtual object in the current season stage is comparatively presented. Only the operation prompt animation is presented in the object presentation frame in middle and later stages of participation of the user in the current season stage, which increases a display ratio of the operation prompt animation.

FIG. 9 is a diagram of an effect of interaction effect comparison in an object presentation frame according to an exemplary embodiment of this application.

As shown in FIG. 9, a historical interaction effect of interaction between a user virtual object 910 and a monster virtual object 920 in a historical season stage is displayed in a comparison prompt animation 900; and a stage interaction effect of interaction between the user virtual object 910 and the monster virtual object 920 in a first season stage is displayed in an operation prompt animation 940.

The comparison prompt animation and the stage prompt animation may be simultaneously displayed in an object presentation frame. This method enables a user to conveniently compare game difficulty in a current season stage and a historical season stage.

In some embodiments, a season stage presentation interface includes a page switching control, the page switching control is configured for switching a display page on the season stage presentation interface, and stage prompt information and value prompt information are displayed on a first display page on the season stage presentation interface. The method further includes: the terminal device cancels displaying the first display page in response to an operation of triggering the page switching control, and displays a second display page on the season stage presentation interface, display content of the second display page including at least one of the following: an incentive mechanism of a season and historical data of the season.

To improve the organization of display content on the season stage presentation interface, different display content may be displayed on different display pages on the season stage presentation interface. The season stage presentation interface includes at least one page switching control, and the page switching control is configured for switching a display page on the season stage presentation interface. A user controls, by triggering the page switching control, the terminal device to switch the display page on the season stage presentation interface.

In an embodiment, the operation of triggering the page switching control includes, but is not limited to, at least one of the following: a click/tap operation, a button-press operation, a slide operation, a long-press operation, and the like. The operation of triggering the page switching control is defined according to actual requirements. This is not limited in this application.

In an example, the season stage presentation interface includes one page switching control, and switching between a plurality of display pages can be completed by using the one page switching control. A display page to be switched to from a current display page is determined according to a number of trigger operations performed on the page switching control from the plurality of display pages. For example, the terminal device determines, according to a number n of times the page switching control is triggered, a target display page to be switched to and displayed on the season stage presentation interface. A switching interval between the target display page and the current display page is equal to n, and n is a positive integer.

It is assumed that the plurality of display pages include a display page 1, a display page 2, a display page 3, and a display page 4, the current display page is the display page 1, and the number of times the page switching control is triggered is two, the terminal device switches the display page 1 to the display page 3 on the season stage presentation interface, that is, the display page 3 is the target display page.

In another example, the season stage presentation interface includes a plurality of page switching controls, and a quantity of the page switching controls is equal to a quantity of the plurality of display pages. In this case, each page switching control in the plurality of page switching controls corresponds to one display page. The terminal device switches the current display page to the target display page on the season stage presentation interface in response to an operation of triggering a page switching control corresponding to the target display page.

In some embodiments, the plurality of display pages respectively include different display content. In an embodiment, the stage prompt information and the value prompt information of the first season stage are displayed on the same display page. To be specific, the stage prompt information and the value prompt information of the first season stage are displayed on the first display page. Exemplarily, the first display page is further configured for displaying the object presentation frame in the foregoing embodiments.

In an embodiment, the second display page refers to any display page in the plurality of display pages other than the first display page. Display content on the second display page is related to a currently ongoing season.

Exemplarily, the display content on the second display page includes at least one of the following: an incentive mechanism of a season and historical data of the season. The incentive mechanism of the season is configured for encouraging users to participate in the ongoing season, and the historical data of the season is configured for representing data related to a historical season stage of the ongoing season. For example, the historical data of the season includes value prompt information of a historical season stage.

The display content on the second display page is set according to actual requirements. This is not limited in this application.

FIG. 10 is a diagram of a display frame of a season stage presentation interface according to an exemplary embodiment of this application.

As shown in FIG. 10, display content on the season stage presentation interface includes stage prompt information, value prompt information of a first season stage, an incentive mechanism of a season, and historical data of the season, and the display content is displayed on different display pages.

In this embodiment, different display pages are set on the season stage presentation interface, and different display content is displayed on the different display pages. Therefore, the layout of the display content on the season stage presentation interface is more proper. This helps a user quickly obtain the display content related to the season via the season stage presentation interface. Moreover, it is convenient to add new display content to the season stage presentation interface in an operation and maintenance update process of a game application program. When new display content needs to be added to the season stage presentation interface, a new display page is set for the new display content, and a page switching control is linked to the new display page. In this way, the new display content can be displayed on the new display page without modifying another display page on the season stage presentation interface. This helps enhance compatibility of the season stage presentation interface with new display content and reduces the workload during maintenance and update of the game application program.

The following introduces and describes how a value range in prompt information of a season stage affects a user in a game with reference to several embodiments. It can be learned from the foregoing embodiments that in this application, to improve game fairness and reduce matching load on a server in a season (especially, in a late stage of the season), a complete season is divided into different season stages, and value ranges are provided for attribute values of virtual objects and attribute values of virtual props in different season stages. As the season progress advances, game difficulty gradually increases, and benefits of playing the game also increase. In this way, the problem of an excessively large user strength difference caused by different game duration is alleviated. The following introduces and describes how value ranges of attribute values in a season stage function with reference to several embodiments.

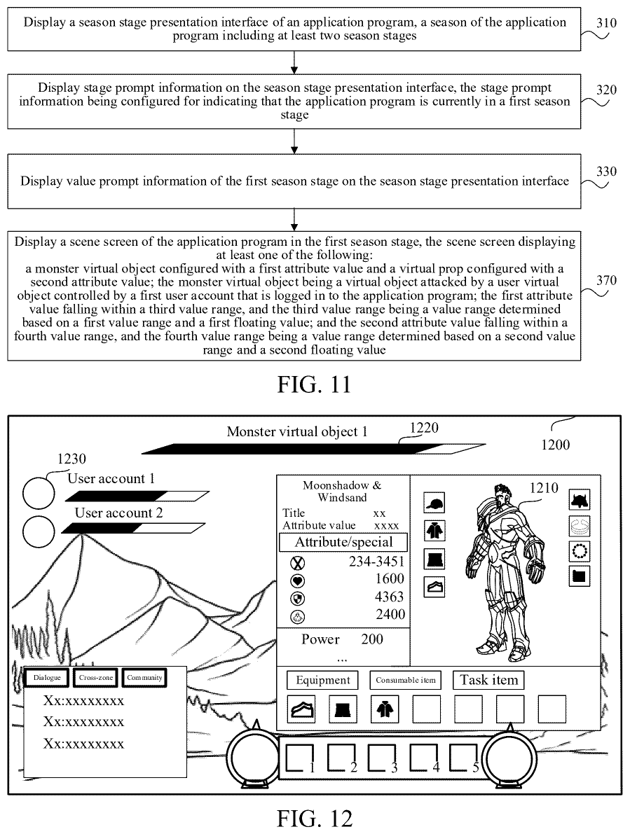

FIG. 11 is a schematic diagram of a season stage presentation method according to another exemplary embodiment of this application. As shown in FIG. 11, the season stage presentation method may include the following several operations. An executive subject of the following several operations is a terminal device.

Operation 310: Display a season stage presentation interface of an application program, a season of the application program including a plurality of season stages.

Operation 320: Display stage prompt information on the season stage presentation interface, the stage prompt information being configured for indicating that the application program is currently in a first season stage.

Operation 330: Display value prompt information of the first season stage on the season stage presentation interface.

For specific content of operation 310, operation 320, and operation 330, refer to the foregoing embodiments. Details are not described again here.

Operation 370: Display a scene screen of the application program in the first season stage, the scene screen displaying at least one of the following: a monster virtual object configured with a first attribute value and a virtual prop configured with a second attribute value; the monster virtual object being a virtual object attacked by a user virtual object controlled by a first user account that is logged in to the application program; the first attribute value falling within a third value range, and the third value range being a value range determined based on a first value range and a first floating value; and the second attribute value falling within a fourth value range, and the fourth value range being a value range determined based on a second value range and a second floating value.

In some embodiments, the scene screen refers to a screen that needs to be displayed when a specified user plays a game in a game application program. In an embodiment, the game provided by the game application program is based on a match system, and a scene screen of the game application program refers to a display screen in a match. One session of the game may include user virtual objects respectively controlled by a plurality of users, or may include only a user virtual object controlled by one user. A number of users participating in the game provided by the game application program is set according to actual requirements. This is not limited herein.

The game provided by the game application program includes at least one of the following: a monster virtual object and a virtual prop. The user may control the user virtual object to perform an interaction operation on the monster virtual object, or may control the user virtual object to use the virtual prop, or to pick up the virtual prop in a virtual environment. The operation performed by the user by controlling the user virtual object is set according to game requirements. This is not defined herein.

In some embodiments, the first floating value includes a first upper limit floating value, and an upper limit value of the third value range is determined based on an upper limit value of the first value range and the first upper limit floating value. The second floating value includes a second upper limit floating value, and an upper limit value of the fourth value range is determined based on an upper limit value of the second value range and the second upper limit floating value.

In an embodiment, the first upper limit floating value and the second upper limit floating value are predetermined. The first upper limit floating value and the second upper limit floating value are positive integers.

Exemplarily, when the attribute value of the user virtual object controlled by the first user account exceeds the range of the first attribute value, the upper limit value of the third value range needs to be determined based on the upper limit value of the first value range and the first upper limit floating value, and the upper limit value of the fourth value range needs to be determined based on the upper limit value of the second value range and the second upper limit floating value.

For example, the upper limit value of the third value range is equal to a sum of the upper limit value of the first value range and the first upper limit floating value, and the upper limit value of the fourth value range is equal to a sum of the upper limit value of the second value range and the second upper limit floating value.

For another example, the upper limit value of the third value range is equal to a ratio of the sum of the upper limit value of the first value range and the first upper limit floating value to the upper limit value of the first value range, and the upper limit value of the fourth value range is equal to a ratio of the sum of the upper limit value of the second value range and the second upper limit floating value to the upper limit value of the second value range.

In an embodiment, a lower limit value of the third value range is equal to the upper limit value of the first value range, and a lower limit value of the fourth value range is equal to the upper limit value of the second value range.

To be specific, in the first season stage, the attribute value of the virtual object fluctuates relative to the first value range based on a first upper limit value, and the attribute value of the virtual prop fluctuates relative to the second value range based on a second upper limit value.

TABLE 1
Design of value ranges in season stages

| | | | | | | |
|---|---|---|---|---|---|---|
| Season stage | Season | Season | Season | Season | Season | Season |
| | stage 1 | stage 2 | stage 3 | stage 4 | stage 5 | stage . . . |
| First | 100-110 | 110-120 | 120-140 | 140-160 | 160-180 | . . . |
| value range | | | | | | |
| Second | 100-120 | 120-140 | 140-160 | 160-180 | 180-200 | . . . |
| value range | | | | | | |
| Benefit | 100 | 120 | 140 | 160 | 180 | . . . |
| of virtual | | | | | | |
| prop | | | | | | |

Exemplarily, an equipment attribute obtained by a user in a season stage only floats above and below a first value range in the season stage by 10 points. For example, in the season stage 1 in Table 1, a current equipment value of a user is 120 (that is, an attribute value of a user virtual object is 120), and in this case, a maximum equipment attribute that can be obtained by the user is equal to an upper limit value (120) of a first value range plus a first upper limit floating value (10), that is, is equal to 130. In the season stage 1, if the attribute value of the user virtual object is equal to 130, an attribute value of a monster virtual object encountered by the user in the game is set based on a first value range in the season stage 2, and an attribute value of a pickable virtual prop encountered by the user in the game is set based on a second value range in the season stage 2.

A complete season is divided into a plurality of different season stages, and attribute values of virtual props and attribute values of monster virtual objects in the season stage are differently set, whereby a monster virtual object with excessively high strength is prevented from appearing in the game, and an impact on game balance, which is caused by an excessively high attribute value of a virtual prop obtained by a user, is also avoided.

When a plurality of users need to be simultaneously matched in one session of a matching game, weighted averaging needs to be performed on attribute values of the same monster virtual object corresponding to the users, and then the weighted average value is compared with the first value range, to determine a final effective value.

In some embodiments, when at least two user virtual objects are matched into one group, the first attribute value and the second attribute value are determined based on a weighted average value of attribute values of the at least two user virtual objects.

In an embodiment, weights respectively corresponding to different user virtual objects may be the same or may be different. Exemplarily, a larger attribute value of a user virtual object indicates a larger weight corresponding to the user virtual object.

Determining the first attribute value and the second attribute value based on a weighted average value of attribute values of at least two user virtual objects can better conform to an actual situation in a game, balance strength of a user virtual object and a monster virtual object, and ensure game playability.

In some embodiments, if the weighted average value of the attribute values of the at least two user virtual objects is greater than or equal to the upper limit value of the first value range, the first attribute value and the second attribute value are related to a second season stage that is in the at least two season stages and that has not started. If the weighted average value of the attribute values of the at least two user virtual objects is less than the lower limit value of the first value range, the first attribute value is equal to the lower limit value of the first value range, and the second attribute value is equal to the lower limit value of the second value range.

The second season stage belongs to the plurality of season stages. The weighted average value of the attribute values of the at least two user virtual objects falls within a first value range in the second season stage. The first attribute value falls within the first value range in the second season stage, and the second attribute value falls within a second value range in the second season stage.

In an embodiment, the second season stage refers to a season stage that is in the at least two season stages and that has not started. An upper limit value of the first value range in the second season stage is greater than the upper limit value of the first value range in the first season stage.

TABLE 2
Determination of first attribute value and second attribute value

| | | | | | | |
|---|---|---|---|---|---|---|
| Single-round | Season | Season | Season | Season | Season | . . . |
| matching | stage 1 | stage 2 | stage 3 | stage 4 | stage 5 | |
| Minimum attribute | 100 | 100 | 100 | 100 | 100 | |
| value in users | | | | | | |
| Maximum attribute | 150 | 120 | 140 | 120 | 160 | |
| value in users | | | | | | |
| Weighted average | 125 | | | 110 | | |
| value | | | | | | |
| Basis for | Season | | | Season | | |
| determining | stage 2 | | | stage 4 | | |
| attribute value | | | | | | |

As shown in Table 2, the first value range in the season stage 1 is 100 to 120. In one session of the matching game, the maximum attribute value in users (namely, the maximum attribute value in user virtual objects respectively controlled by the users participating in the match) is 150, and the minimum attribute value in the users is 100. When the two users participate in the match, a weighted average value of attribute values of user virtual objects is 125, which is higher than the first value range in the season stage 1. It can be learned from an observation with reference to Table 1 that the weighted average value of the attribute values of the user virtual objects falls within the first value range in the season stage 2. That is, the season stage 2 is the second season stage. In this case, the attribute value of the monster virtual object and the attribute value of the virtual prop are determined according to the season stage 2. In this scenario, it is equivalent to that a high-level user accelerates growth of a low-level user, and the low-level user decelerates growth of the high-level user.

In the season stage 4, a first attribute range is 160 to 180. It is assumed that users having attribute values of 100 and 120, respectively, are matched, the two users belong to laggard users, have not kept up with the progress of the season, and are highly probably some returned users, and a weighted average value of the attribute values of the user virtual objects is 110, which is less than a lower limit value (160) of the first value range in the season stage 4. In this case, the attribute value of the virtual object in the match is determined according to the lower limit value of the first value range in the season stage 4.

FIG. 12 is a schematic diagram of a game screen according to an exemplary embodiment of this application.

As shown in FIG. 12, a game scene 1200 includes a user virtual object 1210 controlled by a first user account, a monster virtual object 1220, and user account information 1230 of another user.

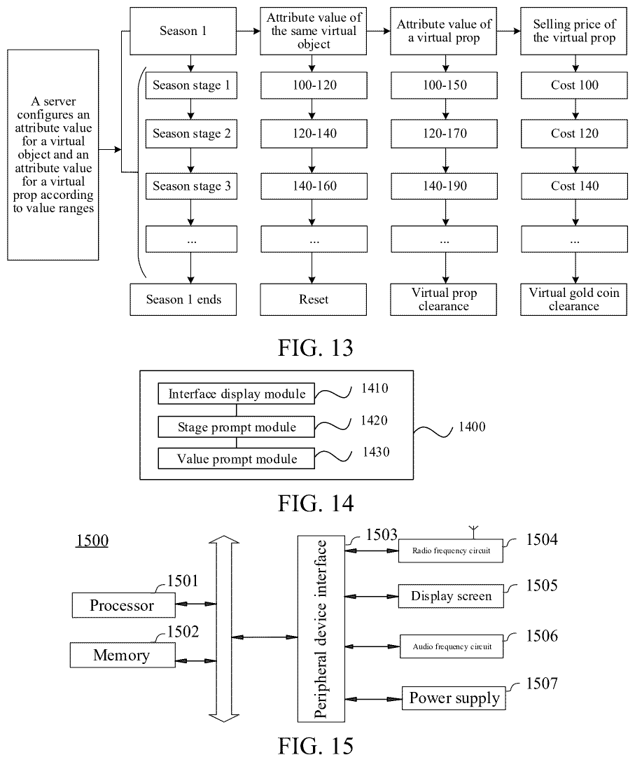

FIG. 13 is a schematic diagram of an attribute value determination process according to an exemplary embodiment of this application.

When a game in a game application program requires participation of a plurality of users, a server determines user virtual objects respectively controlled by the plurality of users, and calculates a weighted average value of attribute values of the plurality of user virtual objects. When the weighted average value is greater than or equal to an upper limit value of a first value range, the server determines a second season stage according to the weighted average value, determines an attribute value of a virtual object in a current match according to a first value range in the second season stage, and determines an attribute value of a virtual prop in the current match according to a second attribute range in the second season stage. When the weighted average value is less than or equal to a lower limit value of the first value range, the server takes the lower limit value of the first value range in the first season stage as the attribute value of the virtual object in the current match, and takes a lower limit value of a second attribute range in the first season stage as the attribute value of the virtual prop in the current match.

This solution resolves the problem of an excessively large “rich-poor gap” in strength in the game. In any time slice within the entire season, a strength difference between a strongest user and a weakest user is relatively calculated, accumulated benefits of the user are weakened, and current benefits of the user are emphasized. In this way, user stickiness can be greatly increased because virtual props can be traded freely in the game. This season stage setting can also effectively eliminate money-making studios and help improve the fairness of the gaming environment.

The following describes apparatus embodiments of this application, and the apparatus is configured to implement the method embodiments of this application. For details not disclosed in the apparatus embodiments of this application, refer to the method embodiments of this application.

FIG. 14 is a block diagram of a season information presentation apparatus according to an exemplary embodiment of this application. The apparatus may be implemented as all or part of a terminal device through software, hardware, or a combination thereof. An apparatus 1400 may include: an interface display module 1410, a stage prompt module 1420, and a value prompt module 1430.

The interface display module 1410 is configured to display a season stage presentation interface of an application program, a season of the application program including at least two season stages.

The stage prompt module 1420 is configured to display stage prompt information on the season stage presentation interface, the stage prompt information being configured for indicating that the application program is currently in a first season stage, and the first season stage being one season stage in the at least two season stages.

The value prompt module 1430 is configured to display value prompt information of the first season stage on the season stage presentation interface, the value prompt information being configured for prompting a value range configured for an interactive object in the application program in the first season stage, and the value range changing as the season stage changes.

In some embodiments, the interactive object includes at least one of the following: a virtual object and a virtual prop. The value prompt information includes at least one of first value prompt information and second value prompt information. The first value prompt information is configured for prompting a first value range configured for an attribute of a virtual object in the first season stage, and the second value prompt information is configured for prompting a second value range configured for an attribute of a virtual prop in the first season stage.

In some embodiments, the attribute of the virtual object includes at least one of the following: a capability of the virtual object and a benefit of the virtual object. The capability of the virtual object gradually increases with the progress of the season stage, and the benefit of the virtual object gradually increases with the progress of the season stage. The attribute of the virtual prop includes at least one of the following: a capability of the virtual prop and a value of the virtual prop. The capability of the virtual prop gradually increases with the progress of the season stage, and the value of the virtual prop gradually increases with the progress of the season stage.

In some embodiments, the apparatus 1400 further includes: a screen display module, configured to display a scene screen of the application program in the first season stage, the scene screen displaying at least one of the following: a monster virtual object configured with a first attribute value and a virtual prop configured with a second attribute value; the monster virtual object being a virtual object attacked by a user virtual object controlled by a first user account that is logged in to the application program; the first attribute value falling within a third value range, and the third value range being a value range determined based on the first value range and a first floating value; and the second attribute value falling within a fourth value range, and the fourth value range being a value range determined based on the second value range and a second floating value.

In some embodiments, when at least two user virtual objects are matched into one group, the first attribute value and the second attribute value are determined based on a weighted average value of attribute values of the at least two user virtual objects.

In some embodiments, if the weighted average value of the attribute values of the at least two user virtual objects is greater than or equal to an upper limit value of the first value range, the first attribute value and the second attribute value are related to a second season stage that is in the at least two season stages and that has not started. If the weighted average value of the attribute values of the at least two user virtual objects is less than or equal to a lower limit value of the first value range, the first attribute value is equal to the lower limit value of the first value range, and the second attribute value is equal to a lower limit value of the second value range.

In some embodiments, the first floating value includes a first upper limit floating value, and an upper limit value of the third value range is determined based on the upper limit value of the first value range and the first upper limit floating value. The second floating value includes a second upper limit floating value, and an upper limit value of the fourth value range is determined based on an upper limit value of the second value range and the second upper limit floating value.

In some embodiments, the stage prompt module 1420 includes: a data obtaining unit, configured to obtain interface display data transmitted by a server, the interface display data being configured for indicating display content on the season stage presentation interface; and a stage display unit, configured to display the stage prompt information in a first display area of the season stage presentation interface according to the interface display data, the first display area referring to a partial area of the season stage presentation interface.

In some embodiments, the stage prompt information includes a prompt icon; and the stage display unit is configured to obtain a display material from a resource package of the application program according to the interface display data, the display material including a background picture of the season and a prompt icon of the first season stage; display the background picture in the first display area; and display the prompt icon of the first season stage on the top of the background picture.

In some embodiments, the apparatus 1400 further includes a presentation frame display module, configured to display an object presentation frame on the season stage presentation interface, the object presentation frame being configured for displaying content related to a user virtual object, and the user virtual object being controlled by a first user account logged in to the application program; and a stage animation display module, configured to display an operation prompt animation of the user virtual object in the object presentation frame in response to an operation of switching display content in the object presentation frame, the operation prompt animation being configured for prompting an interaction effect of interaction between the user virtual object and an interactive object in the first season stage.

In some embodiments, the apparatus 1400 further includes a historical animation display module, configured to display a comparison prompt animation of the user virtual object in the object presentation frame in response to an operation of switching display content in the object presentation frame, the comparison prompt animation being configured for prompting a historical interaction effect of interaction between the user virtual object and an interactive object in a historical season stage, the historical season stage being a season stage that is in the at least two season stages and that has been completed, and the historical interaction effect being different from the interaction effect.

In some embodiments, the interface display module 1410 is configured to obtain an interface display instruction in response to an interface display operation obtained in the first season stage, the interface display instruction being configured for indicating a display timing of the season stage presentation interface; and display the season stage presentation interface according to the interface display instruction if the first user account logged in to the application program satisfies a prompt information presentation condition, the prompt information presentation condition including at least one of the following: the application program being within a season period of the season, a login count of the first user account within a first time period being less than or equal to a threshold, and the first user account being in a state of waiting to join a scene, and the first time period being a period of time in the first season stage.

In some embodiments, the season stage presentation interface includes a page switching control, the page switching control is configured for switching a display page on the season stage presentation interface, and the stage prompt information and the value prompt information are displayed on a first display page on the season stage presentation interface. The apparatus 1400 further includes: a page switching module, configured to cancel displaying the first display page in response to an operation for the page switching control, and display a second display page on the season stage presentation interface, display content of the second page including at least one of the following: an incentive mechanism of the season and historical data of the season.

When the apparatus provided in the foregoing embodiments implements functions of the apparatus, the division of the foregoing functional modules is merely an example for description. In practical application, the foregoing functions may be assigned to and completed by different functional modules according to the requirements, that is, the internal structure of the device is divided into different functional modules, to implement all or some of the functions described above. In addition, the apparatus provided in the foregoing embodiments and method embodiments belong to the same conception. For the specific implementation process, refer to the method embodiments. Details are not described again here. For beneficial effects of the apparatus provided in the foregoing embodiments, refer to the descriptions of the method embodiments. Details are not described again here.

FIG. 15 is a structural block diagram of a terminal device according to an exemplary embodiment of this application.

A terminal device 1500 may be an electronic device such as a mobile phone, a tablet computer, a game console, an e-book reader, a multimedia playback device, a wearable device, or a personal computer (PC). The terminal device is configured to implement the season information presentation method provided in the foregoing embodiments. The terminal device may be the terminal device 10 shown in FIG. 1. Specifically:
the terminal device 1500 typically includes: a processor 1501 and a memory 1502.

The processor 1501 may include one or more processing cores, such as a 4-core processor or an 8-core processor. The processor 1501 may be implemented in at least one hardware form of a digital signal processor (DSP), a field-programmable gate array (FPGA), and a programmable logic array (PLA). The processor 1501 may alternatively include a main processor and a coprocessor. The main processor is a processor configured to process data in an awake state, and is also referred to as a central processing unit (CPU). The coprocessor is a low power consumption processor configured to process data in a standby state. In some embodiments, the processor 1501 may be integrated with a graphics processing unit (GPU). The GPU is configured to render and draw content that needs to be displayed on a display screen. In some embodiments, the processor 1501 may further include an artificial intelligence (AI) processor. The AI processor is configured to process computing operations related to machine learning.

The memory 1502 may include one or more computer-readable storage media. The computer-readable storage medium may be tangible and non-transitory. The memory 1502 may further include a high-speed random-access memory and a non-volatile memory, such as one or more disk storage devices or flash storage devices. In some embodiments, the non-transitory computer-readable storage medium in the memory 1502 has a computer program stored therein, and the computer program is loaded and executed by the processor 1501 to implement the season information presentation method provided in the foregoing method embodiments.

In some embodiments, the terminal device 1500 may further include: a peripheral device interface 1503 and at least one peripheral device. The processor 1501, the memory 1502, and the peripheral device interface 1503 may be connected through a bus or a signal cable. Each peripheral device may be connected to the peripheral device interface 1503 through a bus, a signal cable, or a circuit board. Specifically, the peripheral device includes at least one of a radio frequency circuit 1504, a display screen 1505, an audio frequency circuit 1506, and a power supply 1507.

A person skilled in the art may understand that the structure shown in FIG. 15 is not intended to be constructed as limiting the terminal device 1500, and the terminal device may include more or fewer components than those shown in the figure, or some components may be combined, or a different component deployment may be used.

The embodiments of this application further provide a non-transitory computer-readable storage medium. The storage medium has a computer program stored therein, and the computer program is loaded and executed by a processor to implement the season information presentation method provided in the foregoing method embodiments.

The computer-readable medium may include a computer storage medium and a communication medium. The computer storage medium includes volatile and non-volatile, and removable and non-removable media implemented by any method or technology for storing information such as computer-readable instructions, data structures, program modules, or other data. The computer storage medium includes a random-access memory (RAM), a read-only memory (ROM), an erasable programmable read-only memory (EPROM), an electrically erasable programmable read-only memory (EEPROM), a flash memory or another solid-state memory technology, a digital video disc (DVD) or another optical memory, a tape cartridge, a magnetic tape, a magnetic disk memory, or another magnetic storage device. Certainly, a person skilled in art appreciates that the computer storage medium is not limited to the foregoing several types.

The embodiments of this application further provide a computer program product. The computer program product includes a computer program, the computer program is stored in a non-transitory computer-readable storage medium, and a processor reads the computer program from the computer-readable storage medium and executes the computer program, to implement the season information presentation method provided in the foregoing method embodiments.

“Plurality” mentioned herein means two or more. “And/or” describes an association relationship between associated objects and represents that three relationships may exist. For example, A and/or B may represent the following three cases: only A exists, both A and B exist, and only B exists. The symbol “/” generally indicates an “or” relationship between the associated objects.

The foregoing descriptions are merely preferred embodiments of this application, but are not intended to limit this application. Any modification, equivalent substitution, or improvement made within the spirit and principle of this application fall within the scope of protection of this application.

What is claimed is:

1. A season information presentation method performed by a computer device, the method comprising:
displaying a season stage presentation interface of an application program, a season of the application program comprising at least two season stages;
in response to a first user instruction, displaying stage prompt information on the season stage presentation interface, the stage prompt information indicating that the application program is currently in a first season stage of the at least two season stages;
in response to a second user instruction, replacing the stage prompt information with value prompt information of the first season stage on the season stage presentation interface, the value prompt information prompting a value range configured for an interactive object in the application program in the first season stage; and
changing the value range in response to the application program switching from the first season stage to a second season stage of the at least two season stages.

2. The method according to claim 1, wherein the interactive object comprises at least one of the following: a virtual object and a virtual prop, and the value prompt information comprises at least one of first value prompt information and second value prompt information, the first value prompt information is configured for prompting a first value range configured for an attribute of the virtual object in the first season stage, and the second value prompt information is configured for prompting a second value range configured for an attribute of the virtual prop in the first season stage.

3. The method according to claim 2, wherein
the attribute of the virtual object comprises at least one of the following: a capability of the virtual object and a benefit of the virtual object, the capability of the virtual object gradually increases with the progress of the season stage, and the benefit of the virtual object gradually increases with the progress of the season stage; and
the attribute of the virtual prop comprises at least one of the following: a capability of the virtual prop and a value of the virtual prop, the capability of the virtual prop gradually increases with the progress of the season stage, and the value of the virtual prop gradually increases with the progress of the season stage.

4. The method according to claim 2, wherein the method further comprises:
displaying a scene screen of the application program in the first season stage, the scene screen displaying at least one of the following: a monster virtual object configured with a first attribute value and a virtual prop configured with a second attribute value,
the monster virtual object being a virtual object attacked by a user virtual object controlled by a first user account that is logged into the application program; the first attribute value falling within a third value range, and the third value range being a value range determined based on the first value range and a first floating value; and the second attribute value falling within a fourth value range, and the fourth value range being a value range determined based on the second value range and a second floating value.

5. The method according to claim 4, wherein when at least two user virtual objects are matched into one group, the first attribute value and the second attribute value are determined based on a weighted average value of attribute values of the at least two user virtual objects.

6. The method according to claim 5, wherein
when the weighted average value of the attribute values of the at least two user virtual objects is greater than or equal to an upper limit value of the first value range, the first attribute value and the second attribute value are related to a second season stage that is in the at least two season stages and that has not started; and
when the weighted average value of the attribute values of the at least two user virtual objects is less than or equal to a lower limit value of the first value range, the first attribute value is equal to the lower limit value of the first value range, and the second attribute value is equal to a lower limit value of the second value range.

7. The method according to claim 4, wherein
the first floating value comprises a first upper limit floating value, and an upper limit value of the third value range is determined based on the upper limit value of the first value range and the first upper limit floating value; and
the second floating value comprises a second upper limit floating value, and an upper limit value of the fourth value range is determined based on an upper limit value of the second value range and the second upper limit floating value.

8. The method according to claim 1, wherein the displaying stage prompt information on the season stage presentation interface comprises:
obtaining interface display data transmitted by a server, the interface display data indicating display content on the season stage presentation interface; and
displaying the stage prompt information in a first display area of the season stage presentation interface according to the interface display data.

9. The method according to claim 8, wherein the stage prompt information comprises a prompt icon; and
the displaying the stage prompt information in a first display area of the season stage presentation interface according to the interface display data comprises:
obtaining a display material from a resource package of the application program according to the interface display data, the display material comprising a background picture of the season and a prompt icon of the first season stage;
displaying the background picture in the first display area; and
displaying the prompt icon of the first season stage on the top of the background picture.

10. The method according to claim 1, wherein the method further comprises:
displaying an object presentation frame on the season stage presentation interface, the object presentation frame being configured for displaying content related to a user virtual object controlled by a first user account logged in to the application program; and
displaying an operation prompt animation of the user virtual object in the object presentation frame in response to an operation of switching display content in the object presentation frame, the operation prompt animation being configured for prompting an interaction effect of interaction between the user virtual object and the interactive object in the first season stage.

11. The method according to claim 10, wherein the method further comprises:
displaying a comparison prompt animation of the user virtual object in the object presentation frame in response to an operation of switching display content in the object presentation frame, the comparison prompt animation being configured for prompting an interaction effect of interaction between the user virtual object and an interactive object in a historical season stage, and the historical season stage being a season stage that is in the at least two season stages and that has been completed.

12. The method according to claim 1, wherein the displaying a season stage presentation interface of an application program comprises:
obtaining an interface display instruction in response to an interface display operation obtained in the first season stage, the interface display instruction indicating a display timing of the season stage presentation interface; and
displaying the season stage presentation interface according to the interface display instruction if the first user account logged in to the application program satisfies a prompt information presentation condition, the prompt information presentation condition comprising at least one of the following: the application program being within a season period of the season, a login count of the first user account within a first time period being less than or equal to a threshold, and the first user account being in a state of waiting to join a scene, and the first time period being a period of time in the first season stage.

13. The method according to claim 1, wherein the season stage presentation interface comprises a page switching control for switching a display page on the season stage presentation interface, and the stage prompt information and the value prompt information are displayed on a first display page on the season stage presentation interface; and
the method further comprises:
canceling displaying the first display page in response to an operation of triggering the page switching control, and displaying a second display page on the season stage presentation interface, display content of the second display page comprising at least one of the following:
an incentive mechanism of the season and historical data of the season.

14. A computer device comprising a processor and a memory, the memory having a computer program stored therein, and the computer program, when loaded and executed by the processor, causing the computer device to implement a season information presentation method including:
displaying a season stage presentation interface of an application program, a season of the application program comprising at least two season stages;
in response to a first user instruction, displaying stage prompt information on the season stage presentation interface, the stage prompt information indicating that the application program is currently in a first season stage of the at least two season stages;
in response to a second user instruction, replacing the stage prompt information with value prompt information of the first season stage on the season stage presentation interface, the value prompt information prompting a value range configured for an interactive object in the application program in the first season stage; and
changing the value range in response to the application program switching from the first season stage to a second season stage of the at least two season stages.

15. The computer device according to claim 14, wherein the interactive object comprises at least one of the following: a virtual object and a virtual prop, and the value prompt information comprises at least one of first value prompt information and second value prompt information, the first value prompt information is configured for prompting a first value range configured for an attribute of the virtual object in the first season stage, and the second value prompt information is configured for prompting a second value range configured for an attribute of the virtual prop in the first season stage.

16. The computer device according to claim 14, wherein the displaying stage prompt information on the season stage presentation interface comprises:
obtaining interface display data transmitted by a server, the interface display data indicating display content on the season stage presentation interface; and
displaying the stage prompt information in a first display area of the season stage presentation interface according to the interface display data.

17. The computer device according to claim 14, wherein the method further comprises:
displaying an object presentation frame on the season stage presentation interface, the object presentation frame being configured for displaying content related to a user virtual object controlled by a first user account logged in to the application program; and
displaying an operation prompt animation of the user virtual object in the object presentation frame in response to an operation of switching display content in the object presentation frame, the operation prompt animation being configured for prompting an interaction effect of interaction between the user virtual object and the interactive object in the first season stage.

18. The computer device according to claim 14, wherein the displaying a season stage presentation interface of an application program comprises:
obtaining an interface display instruction in response to an interface display operation obtained in the first season stage, the interface display instruction indicating a display timing of the season stage presentation interface; and
displaying the season stage presentation interface according to the interface display instruction if the first user account logged in to the application program satisfies a prompt information presentation condition, the prompt information presentation condition comprising at least one of the following: the application program being within a season period of the season, a login count of the first user account within a first time period being less than or equal to a threshold, and the first user account being in a state of waiting to join a scene, and the first time period being a period of time in the first season stage.

19. The computer device according to claim 14, wherein the season stage presentation interface comprises a page switching control for switching a display page on the season stage presentation interface, and the stage prompt information and the value prompt information are displayed on a first display page on the season stage presentation interface; and
the method further comprises:
canceling displaying the first display page in response to an operation of triggering the page switching control, and displaying a second display page on the season stage presentation interface, display content of the second display page comprising at least one of the following: an incentive mechanism of the season and historical data of the season.

20. A non-transitory computer-readable storage medium having a computer program stored therein, and the computer program, when loaded and executed by a processor of a computer device, causing the computer device to implement a season information presentation method including:
displaying a season stage presentation interface of an application program, a season of the application program comprising at least two season stages;
in response to a first user instruction, displaying stage prompt information on the season stage presentation interface, the stage prompt information indicating that the application program is currently in a first season stage of the at least two season stages;
in response to a second user instruction, replacing the stage prompt information with value prompt information of the first season stage on the season stage presentation interface, the value prompt information prompting a value range configured for an interactive object in the application program in the first season stage; and
changing the value range in response to the application program switching from the first season stage to a second season stage of the at least two season stages.
